(19) United States
(12) Patent Application Publication
(10) Pub. No.: US 2009/0286057 A1
(43) Pub. Date: Nov. 19, 2009

(54) Self-supporting multilayer films having a diamond-like carbon layer

(76) Inventors: Stefan Zeisler, Vancouver (CA); Vinder Jaggi, Surrey (CA); Nalin Kumar, Fort Worth, TX (US)

Correspondence Address: HARNESS, DICKEY & PIERCE, P.L.C., P.O. BOX 8910, RESTON, VA, 20195, US

(21) Appl. No.: 12/458,722

(22) Filed: Jul. 21, 2009

Related U.S. Application Data
(62) Division of application No. 11/723,084, filed on Mar. 16, 2007.
(60) Provisional application No. 60/783,055, filed on Mar. 17, 2006.

(51) Int. Cl. B32B 9/04

(52) U.S. Cl. 428/216

(57) ABSTRACT

Disclosed are a variety of self-supporting, multilayer carbon films that include a layer of both a non-diamond-like carbon, for example, graphitic or amorphous carbon (or a-C), and a layer of diamond-like carbon (DLC). A wide range of multilayer configurations may be constructed depending on the particular combination of properties desired in the final product including, for example, a tri-layer construction including a single DLC layer sandwiched between two layers of amorphous carbon. Also disclosed are example embodiments of methods for producing such composite multilayer films that include preparing an appropriate substrate to include a deposition surface of sufficient smoothness, applying a parting or release agent to the deposition surface, depositing a plurality of layer carbon layers including both an amorphous carbon layer and a DLC layer to form the composite carbon film and removing the composite carbon film from the substrate.

### CROSS REFERENCE TO RELATED APPLICATIONS

This application claims priority under 35 U.S.C. § 121 as a divisional of U.S. application Ser. No. 11/723,084, filed Mar. 16, 2007, which claims priority under 35 U.S.C. § 119(e) to U.S. Provisional Application No. 60/783,055, filed Mar. 17, 2006, the entire contents of each of which are hereby incorporated herein by reference.

### BACKGROUND

Carbon films are used for a variety of applications including, for example, as accelerator targets, x-ray filters, isotopic targets, backscattering (RBS) calibration targets, beam strippers, charge-changing targets, nuclear targets, in-line attenuators, extreme ultraviolet (EUV) filters, electron-microscopy substrates and many other applications.

Self-supporting carbon thin films for such applications may be produced using a variety of techniques including, for example resistance evaporation under high vacuum during which carbon is deposited on a glass plate that is covered with an organic material that is soluble in water. The soluble interlayer is subsequently dissolved to release the carbon film that is then applied to a frame, such as an aluminum frame, that can then be positioned within a beam path. Thin films having a film or bias weight from about 5 μg/cm² to about 1000 μg/cm² can be produced using this method.

In order to be useful in self-supporting applications, the carbon thin films need to be formed with little residual tension to avoid curling and/or puckering of the resulting film. One particular method of forming a carbon interlayer film involved releasing carbon into a vacuum chamber through resistance heating of carbon source materials for deposition on glass plates previously coated with a saturated solution of betaine and saccharose provided in solution at a ratio of, for example, 7:1.

Crystallization of the interlayer sugar can be suppressed by applying the interlayer under controlled humidity of at least 40% relative humidity and maintaining the coated glass plates under high vacuum until application of the carbon. In this instance, the carbon was released by heating fixed graphite rods to a temperature sufficient to induce sublimation. The sublimed carbon was then deposited on the coated plates provided within the reactor. After the deposition was complete, the coated plates were removed from the reactor and placed in a water bath in which the interlayer material dissolved and released the carbon layer. The released carbon layer floated to the surface of the water bath where it could be removed from the bath using a suitable frame.

These carbon films, however, have certain limitations particularly when employed as stripping or extraction foils in high beam current applications including, for example, their relative fragility and the accumulated damage resulting from the beam impact. The example embodiments are directed to improved carbon films that may exhibit both improved initial mechanical properties as well as improved lifetime, thereby reducing maintenance and operator exposure. The example embodiments are also directed to methods of manufacturing such films.

### SUMMARY

Disclosed are example embodiments of self-supporting, carbon films comprising multilayer structures that include both a layer of amorphous carbon (or a-C), i.e., carbon that exhibits, at best, only short-range atomic order, and a layer of Diamond-like Carbon (DLC). As will be appreciated, a wide range of multilayer configurations are possible depending on the combination of properties desired for the final product. As will be appreciated by those skilled in the art, the simplest configurations will include only one layer of amorphous carbon and one layer of DLC. More complex multilayer configurations will include a plurality of amorphous carbon layers and/or a plurality of DLC layers, for example a single DLC layer sandwiched between two layers of amorphous carbon.

An example embodiment of a method for producing such a composite multilayer film, in this instance, for example, a three-layer film comprising a DLC layer sandwiched between two a-C layers, includes preparing an appropriate substrate, typically a highly polished glass or sapphire substrate, applying an optional layer of a parting or release agent, depositing a first layer of amorphous carbon on the substrate or the release agent, depositing a DLC layer on the first amorphous carbon layer, depositing a second layer of amorphous carbon on the DLC layer, conducting an optional anneal of the composite carbon film and removing the composite carbon film from the substrate. As will be appreciated, the structure of the composite films that may be produced using this method may be adapted as necessary to provide customized composite films having a range of properties particularly suited to a specific application.

### BRIEF DESCRIPTION OF THE DRAWINGS

The scope of the disclosure will become more apparent when the detailed written description provided below is considered in light of the example embodiments as illustrated in the attached drawings in which:

FIG. 1 illustrates an example embodiment in which a multilayer composite carbon film is formed on a substrate;

FIG. 2A illustrates an example embodiment of a method for manufacturing a self-supporting composite carbon film;

FIG. 2B illustrates another example embodiment of a method for manufacturing a self-supporting composite carbon film;

FIG. 2C illustrates another example embodiment of a method for manufacturing a self-supporting composite carbon film;

FIG. 3 illustrates an example embodiment of a method for releasing a self-supporting composite carbon film from a substrate;

FIGS. 4A and 4B illustrate an example embodiment of a carrier or frame assembly that can be used in the manufacture of self-supporting composite carbon films; and

FIGS. 5A and 5B illustrate an example embodiment of a method of manufacturing a self-supporting composite carbon films using a carrier or frame assembly according to FIGS. 4A and 4B.

These drawings have been provided to assist in the understanding of the exemplary embodiments which are described in more detail below and should not be construed as unduly limiting the scope of the disclosure or the appended claims. In particular, the relative spacing, positioning, sizing and dimensions of the various elements illustrated in the drawings are not drawn to scale and may have been exaggerated, reduced or otherwise modified for the purpose of improved clarity.

### DETAILED DESCRIPTION

Diamond-like carbon (DLC) (also known as tetrahedral amorphous carbon, or ta-C) is an amorphous, i.e., lacking long-range order, metastable material. The designation “diamond-like” has been widely adopted by those skilled in the art to describe this class of materials that are characterized by properties that are, to a certain extent, similar to those of diamond including, for example, extreme hardness, high wear resistance, low friction coefficient, chemical inertness, high electrical resistance, and optical transparency in the visible and infrared but yet lack the long-range order characteristics of diamond.

Diamond and graphite are stable forms of carbon having well-defined crystallographic structures. Natural diamond is a crystalline material, and the diamond films fabricated by various CVD methods are composed of diamond microcrystallites up to tens of microns in size. Crystalline diamond is composed substantially entirely of tetrahedrally coordinated sp³-bonded carbon. Diamond and diamond films are those that are constituted from a material having well-defined properties and long-range order in their crystalline structure.

In contrast to diamond films, DLC films lack any long-range order and contain a mixture of sp³⁻, sp²⁻, and, sometimes, even sp¹-coordinated carbon atoms distributed throughout a highly disordered network. The ratio between the carbon atoms in the different atomic coordinations depends to some extent on the formation method and the formation conditions and, in hydrogenated DLC films, has been found to be a strong function of the hydrogen content of the resulting film. While DLC films lack any discernible long-range order, DLC films may exhibit varying degrees of medium-range ordering whereby DLC films may be manufactured to provide a wide range of values generally falling between those of diamond and graphite films.

Self-supporting, carbon films according to the example embodiments are multilayer structures including both a layer of amorphous carbon (or a-C), i.e., carbon that exhibits, at best, only short-range atomic order and no significant crystalline structure, and a thin layer of DLC. As will be appreciated, a wide range of layer configurations are possible depending, in large part, on the combination of physical properties including, for example, strength, stiffness and heat conduction, that allow the multilayer composite structures to be tailored to provide a combination of properties preferred for a particular application intended for the final product. The simplest configuration would consist of one layer of amorphous carbon and one layer of DLC. Another configuration consists of a layer of DLC sandwiched between two layers of amorphous carbon.

An example embodiment of a method for producing such a composite film, in this instance a three-layer film, includes the steps of preparing an appropriate substrate, typically a highly polished glass or sapphire substrate, applying a layer of a soluble parting or release agent, depositing a first layer of amorphous carbon on the release agent, depositing a DLC layer on the first amorphous carbon layer, depositing a second layer of amorphous carbon on the DLC layer, annealing the composite carbon film and removing the composite carbon film from the substrate. As noted above, the structure of the composite films including, for example, the number of layers, the relative thickness of the layers and the overall thickness of the structure, may be adapted as necessary to provide customized composite films having a range of properties better suited to a specific application.

For example, the relative thicknesses and compositions of the various layers can be varied widely to provide, for example, layer thickness ratios of 500:1 or more, the number and sequence of the layers can be modified to produce, for example, composite films having 2, 3, 5, 10 or even more than 50 layers and/or multilayer composite films that include two or more distinct layer compositions. Further, one or more of the incorporated layers may be modified through the addition of other materials, for example, dopants and/or metals, to all or only a portion of a layer using any suitable conventional process in order to tailor the performance of the resulting composite film.

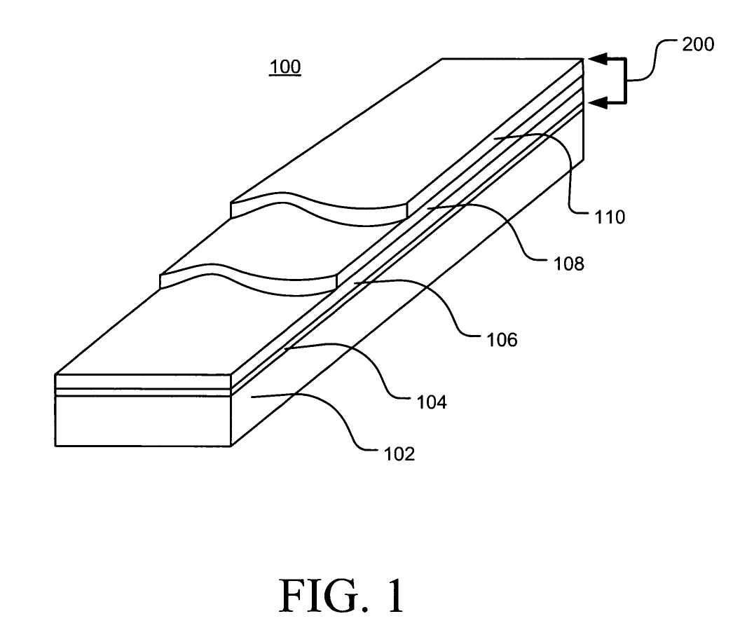

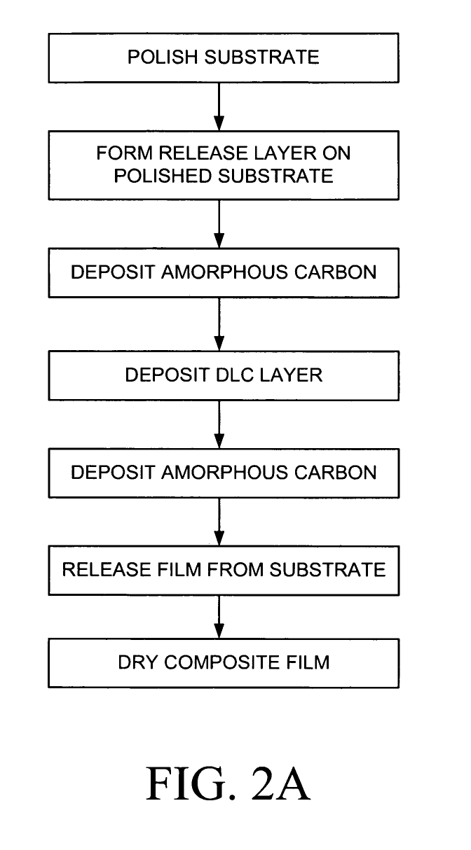

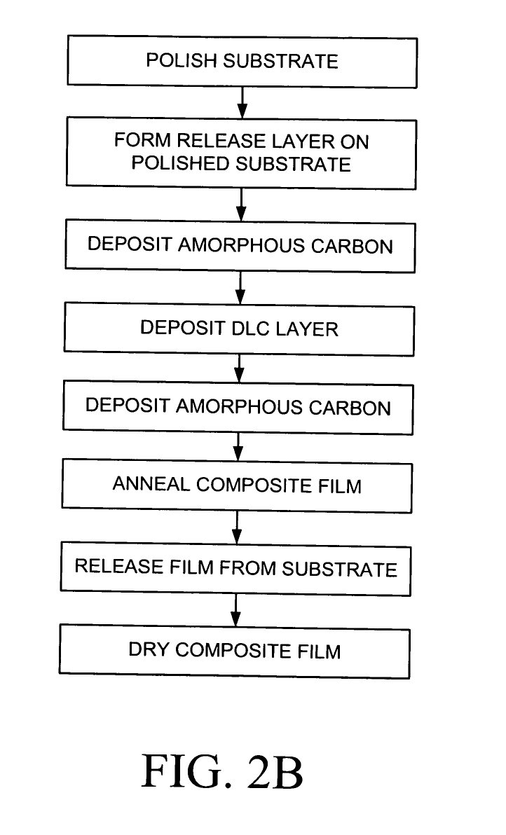

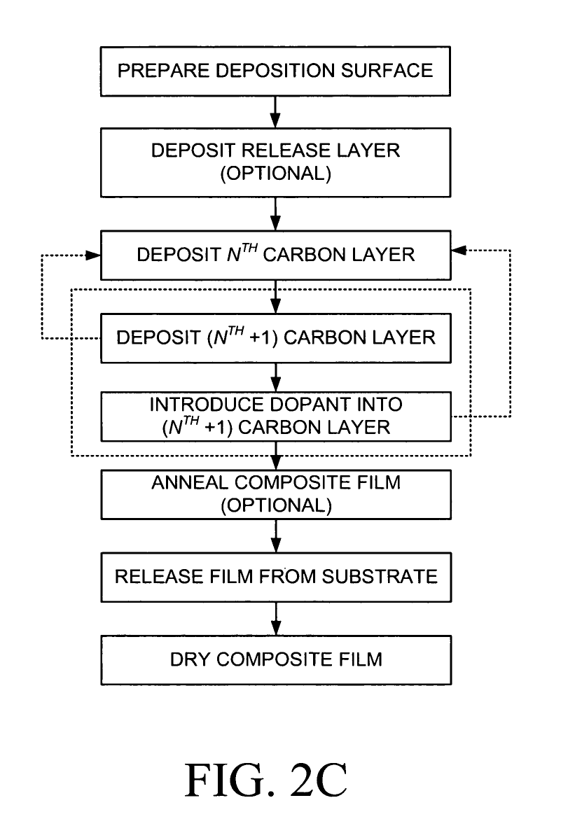

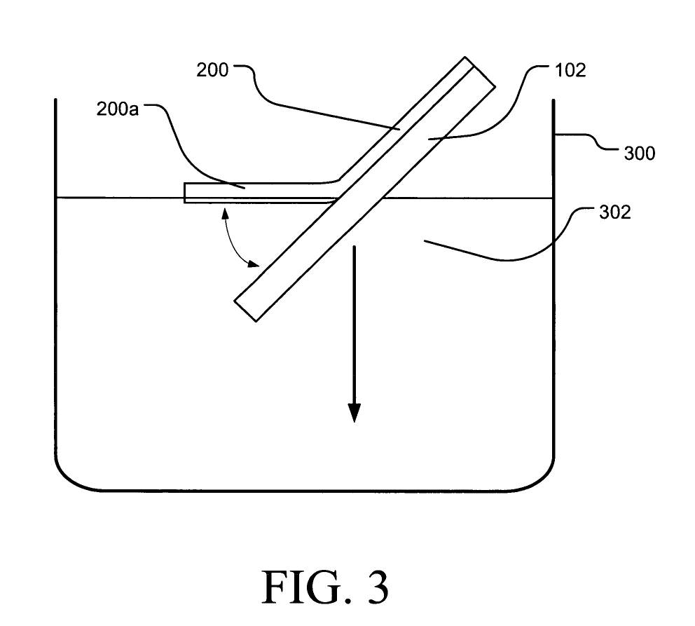

Such a structure 100 including a composite carbon film 200 formed on a substrate 102 is illustrated in FIG. 1. FIG. 1 illustrates a structure according to the example embodiments at the conclusion of deposition cycles in which a first amorphous carbon layer 106 is formed on a release layer 104, a DLC layer 108 is formed on the first a-C layer and a second a-C layer 110 is subsequently formed on the DLC layer. The steps involved in fabricating this structure are reflected in the process flowcharts illustrated in FIGS. 2A and 2B. FIG. 3 illustrates a method of removing the composite carbon film 200 from the substrate 102 by slowing lowering the substrate into a tank 300 containing suitable solvent 302 whereby the release film is dissolved and the freed or released portion 200a of the composite film is supported on the surface of the solvent.

FIG. 2C illustrates an example method that may be used in forming a broader range of multilayer composite carbon layers in which at least one DLC layer is incorporated. As reflected in FIG. 2C, a series of carbon layers is sequentially deposited, inter alia, on the deposition region provided on the substrate and the deposition and doping processes may be repeated as necessary to provide the desired multilayer composite carbon film or structure. As will be appreciated by those skilled in the art, a range of carbon morphologies may be incorporated in a single composite structure including a non-diamond-like carbon layer, for example, a-C, graphitic carbon, pyrolytic carbon and a DLC layer. Further, as noted in FIG. 2C, in certain instances the release layer may be omitted without unduly complicating the removal of the resulting carbon structure.

Similarly, if desired, a range of dopants and/or other materials may be incorporated into one or more of the carbon layers using any suitable technique including, for example, a generally simultaneous process such as co-deposition (as indicated by the dashed box enclosing both the deposition and doping steps), or by using separate and distinct doping methods that may include, for example, diffusion, ion-implantation and/or adsorption to “load” at least the outermost the carbon layer with a target quantity of one or more desired heterogeneous atoms, compounds and/or other materials. As suggested in FIG. 2C, the sequence of carbon layer deposition and optional doping of the deposited carbon layer(s) may be repeated as necessary to obtain a multilayer composite carbon film exhibiting a desired combination of properties including, for example, strength, stress, thickness and/or doping. Dopants may include, for example, metals, nonmetals, combinations of metals and nonmetals, p-type dopants, n-type dopants, oxides, nitrides and carbides thereof.

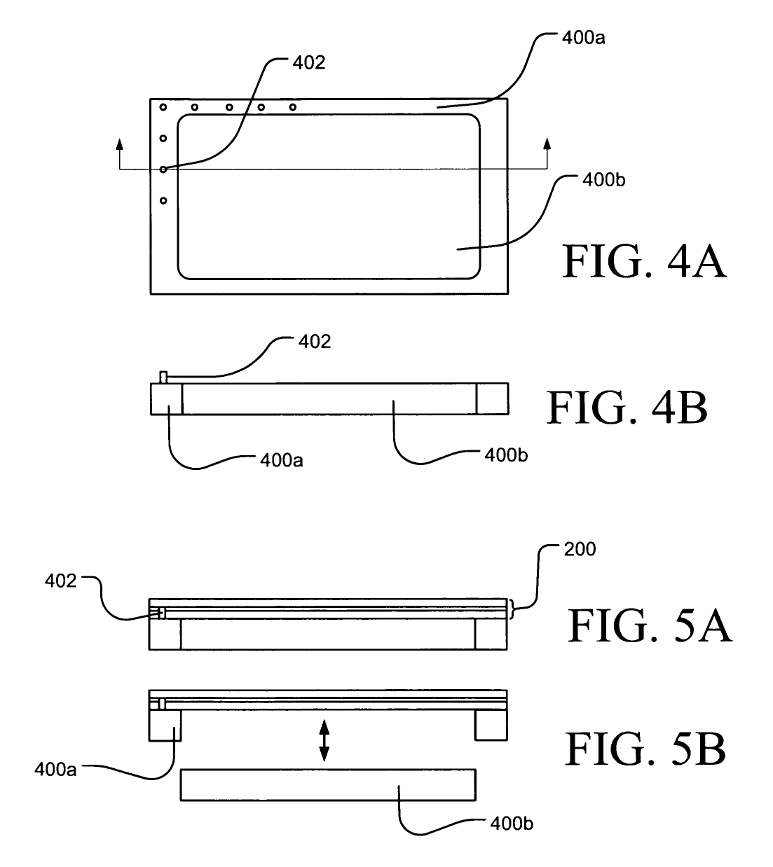

FIGS. 4A-5B illustrate another example embodiment of a method of forming a composite film directly on a film carrier or target frame 400a, 400b in which the composite film 200 is formed on a multi-component assembly, after which an inner portion 400b of the assembly is removed. The frame may be provided with additional structures, for example, protrusions 402 and/or recesses (not shown), that will tend to increase the attachment between the composite film and the peripheral portions of the frame. As will be appreciated, in those instances in which protrusions 402 and/or recesses are utilized on the frame, the pattern will tend to continue around the entire perimeter. The peripheral portions of the frame may also be excluded from treatment with the release agent, thereby increasing the adhesion between the composite film and the peripheral portions of the frame. It is anticipated that in at least some applications, the composite film formed on the frame will not need to be annealed, the residual tension in the film serving to maintain the composite film in a generally planar configuration.

As will be appreciated by those skilled in the art, the particular solvent or solvent system will be selected on the basis of both its ability to penetrate and dissolve the release agent as well as its lack of contaminants (for example, metals) that would degrade the performance of the resulting composite carbon film and/or require additional processing steps to reduce or remove the contaminants. The solvent may also be heated and/or agitated to increase the dissolution rate.

As noted above, the drawings are provided for illustrative purposes only and are not drawn to scale. As will be appreciated by those skilled in the art, the spatial relationships and relative sizing of the elements illustrated in the various example embodiments, for example, the various films comprising the substrate, the release layer and the composite carbon film, may have been reduced, expanded or rearranged to improve the clarity of the figure with respect to the corresponding description. The figures, therefore, should not be interpreted as accurately reflecting the relative sizing, value or positioning of the corresponding structural elements that could be encompassed by actual substrates and composite carbon films manufactured according to the example embodiments.

Depending on the intended application, the recovered composite carbon film may be dried before use or simply mounted on an appropriate fixture or frame and subsequently dried in situ through application of heat and/or vacuum. When use as, for example, stripping foils, the composite carbon films according to the example embodiments exhibit improved durability and increased useful lifetime (as measured by, for example, μA-hrs) relative to commercially available carbon foils. Accordingly, the resulting composite carbon foils are easier to handle and install, will tend to exhibit improved extracted beam quality (as reflected in, for example, the parameters of beam density and stability) and will tend to reduce the operators' radiation exposure by reducing the frequency and simplifying the maintenance procedures associated with changing foils.

Indeed, comparative lifetime testing between conventional amorphous carbon stripping foils (having a thickness of 2.0±0.2 μm) and multilayer composite carbon stripping foils prepared in accord with the procedures and structures detailed herein (having a thickness of 2.0±0.2 μm and including a 0.5 nm DLC layer between two 0.75 μm amorphous carbon layers) produced the results displayed below in TABLE 1.

TABLE 1

| | Cyclotron 1 | Cyclotron 2 |
|---|---|---|
| a-C | 12780 μAh | 13107 μAh |
| a-C/DLC/a-C | 35408 μAh | 41457 μAh |
| Improvement Factor | 2.8 | 3.2 |

The depositions of the amorphous carbon and the DLC films may be achieved using any appropriate method including, for example, chemical vapor deposition (CVD), low-pressure chemical vapor deposition (LPCVD), plasma enhanced chemical vapor deposition (PECVD), pulsed laser deposition (PLD), laser ablation (LA), arc-discharge, microwave plasmas, high-density plasma (HDP) and electron cyclotron resonance chemical vapor deposition (ECR CVD). Further, although the deposition or formation of both types of film can be achieved in a single reactor, it is contemplated that in most instances different reactors (or different reactor chambers in a multi-position unit) will be used to form the amorphous carbon and DLC layers respectively.

Another example embodiment of a method for manufacturing the composite layers includes selecting and preparing the substrate. The material selected for the substrate should be capable of enduring the expected process conditions, e.g., temperature, pressure, and solvents, without suffering significant degradation. The material utilized as the substrate should also include at least one major deposition surface or region suitable for receiving a high surface polish to remove substantially all gross surface defects, e.g., pits and/or scratches prior to deposition. Glass (silica), quartz, alumina (sapphire), refractory metals, semiconductors, oxides, nitrides and carbides are expected to be suitable substrate materials for at least certain methods in accord with the example embodiments and anticipated usage.

The substrate may be monolithic (uniform) or may have a multilayer structure including two or more substrate materials. The size and shape of the substrate will be a function of both the intended application for the resulting composite carbon film and the capabilities of the reactors in which the layer depositions will be conducted. In many instances a glass substrate approximately the size of a standard microscope slide (about 25 mm×75 mm) may serve as a satisfactory substrate. As noted above, the substrate material is not limited to glass, but may comprise or include materials including quartz, sapphire, metal (e.g., molybdenum), oxides, nitrides and carbides.

As will be appreciated, alternative substrate constructions may be utilized in which the substrate itself is soluble in an appropriate solvent, including, for example, various salts that can be processed to provide a deposition surface with an acceptable degree of flatness and uniformity. These soluble substrates can then be dissolved in an appropriate volume of a suitable solvent to release the composite multilayer carbon film. Similarly, when utilizing relatively lower temperature carbon deposition methods, various organic materials may utilized as substrates, again provided that they can be manufactured and/or processed to provide a deposition surface with an acceptable degree of flatness and uniformity. These organic substrates can then be dissolved in an appropriate solvent in order to release the composite multilayer carbon film.

In those instances in which a parting agent is utilized between the substrate and the composite multilayer carbon film, particularly with respect to soluble parting agents, the substrate may be configured to increase the rate of dissolution of the parting agent. In particular, substrates can be configured with pores and/or channels that will allow the solvent to contact a greater area of the parting agent layer during exposure to the solvent, whether by immersion, spraying, puddling or other method of applying one or more solvents to the substrate in order to separate the composite multilayer carbon film from the substrate.

As will also be appreciated, in those instances in which the optional parting agent includes one or more photosensitive compounds, the substrate may be selected and/or configured to improve the transmission of the light energy and/or increase the intensity of the light energy incident on the parting agent layer relative to more general and/or unaltered substrates. Similarly, in those instances in which the optional parting agent includes one or more thermal sensitive compounds, the substrate may be selected and/or configured to provide increased thermal conductivity and/or to incorporate one or more heating assemblies to provide for an enhanced thermal breakdown of the parting agent relative to more general and/or unaltered substrates.

The deposition surface of the substrate should be polished, for example using a chemical-mechanical polishing (CMP) apparatus or other suitable apparatus to obtain a smooth, and preferably flat, surface having a surface roughness on the order of a few microns, preferably a surface roughness of 1 μm or less. The deposition surface may be cleaned by rinsing the surface with an appropriate solvent (e.g., ethanol) and careful wiping with paper tissues, for example, KIMWIPES™ or similar materials. The cleanliness and uniformity of the deposition surface may be analyzed, for example, using a laser scattering device, to verify that the surface is sufficiently free of defects before proceeding to the deposition steps.

Once the deposition surface has been prepared, a thin layer of a suitable release layer, parting agent or combination thereof may be applied to the deposition surface to assist in the separation of the composite multilayer carbon film from the substrate. A wide range of materials may be used for forming the release layer including, for example, one or more inorganic salts, such as sodium chloride and/or barium chloride. The parting agent may be applied by various methods including both “dry” methods such as evaporation or gas phase deposition or “wet” methods such as applying a solution of one or more organic compounds and/or inorganic compounds can be applied and then dried or “cured” to form the release layer. Suitable organic parting agents include surfactants, such as detergents (e.g., dish soap compositions) and sugars with those parting agents exhibiting good aqueous solubility, low volatility and sufficient thermal stability being preferred. As noted above, the use of a parting agent or release agent is optional and is generally intended to reduce the mechanical effort necessary to remove the composite multilayer carbon film from the substrate. As will be appreciated, however, depending on the nature of the deposition surface provided on the substrate and the composite multilayer carbon film, mechanical methods alone may be adequate to separate the composite multilayer carbon film from the substrate.

Once the release layer has been formed on the substrate, the prepared substrate may be stored or placed directly into a first reactor chamber. For those deposition techniques conducted under reduced pressure, the reactor chamber may be evacuated to establish a target vacuum reading suitable for the deposition process. For example, in preparation for the deposition of the first a-C layer, the cleaned and coated substrates may be mounted on a holder inside the vacuum chamber of an amorphous carbon arc deposition system adjacent one or more graphite rods from which the carbon will be transferred to the substrate. The chamber is evacuated using a mechanical pump and a cryogenic pump to a deposition pressure, for example on the order of 10⁻⁵ Pa, and an electrical current is established to the graphite rod, thereby causing some of the carbon from the graphite rod to vaporize and deposit on the substrate.

The deposition of an amorphous carbon layer using the carbon arc method may include applying an electric current of approximately 50-200 amperes through the carbon rods, depending on their diameter and the desired deposition rate. Carbon evaporates from the rods and is deposited on the substrates, forming a layer of amorphous carbon. The deposition can be operated substantially continuously or in a pulse mode with intervals of up to several minutes or more between relatively brief deposition pulses of, for example, less than 10 seconds. The thickness of the deposited layer may be estimated using a standard crystal thickness monitor with the deposition process being terminated when the desired thickness has been reached.

Once the desired a-C thickness has been reached, for example, 0.1-20 μm, for a stripping foil, the deposition can be terminated, the vacuum released and the coated substrate removed from the a-C reactor and placed in a DLC reactor chamber. As noted above, depending on the configuration of the equipment, the coated substrate may be moved from an a-C reactor chamber to a DLC reactor chamber within the same apparatus, thereby avoiding the necessity of releasing the vacuum and conducting an external transfer with its associated risk of contamination. As noted above, the substrate, with its initial a-C layer, is placed in an appropriate DLC reactor chamber and the conditions within the reactor chamber are adjusted to within ranges suitable for the particular deposition technique being utilized, e.g., laser ablation, which may be similar or even identical to the conditions under which the first a-C layer was formed.

If a laser ablation technique is utilized, the reactor chamber may be evacuated to a high vacuum under which carbon is evaporated by a high power laser beam impinging upon a rotating carbon disc. The carbon vapor, which is believed to consist primarily of single atoms and/or small atomic clusters, are deposited on the substrate to form microcrystalline diamond-like carbon structures. In general, the deposition rate of laser ablation systems is relatively low and may require deposition periods as long as several hours or even days, depending on the desired thickness of the DLC layer. In the case of stripping foils, for example, a DLC thickness on the order of 0.1-10 μm, is expected to be suitable for most stripping foil applications. Once a DLC layer of suitable thickness has been formed, the deposition may be terminated, the vacuum released and the substrate removed from the DLC reaction chamber.

Once the DLC layer has been formed on the substrate, the coated substrate may be stored or placed directly into a reactor chamber for deposition of a second a-C layer. Again, for those deposition techniques practiced under reduced pressure, the reactor chamber may be evacuated to establish a suitable target vacuum reading. If a carbon arc process is utilized and an electrical current is established to the graphite rod, thereby causing some of the carbon from the graphite rod to vaporize and deposit on the substrate.

Once the composite carbon layer has been formed, in this instance a multi-layer a-C/DLC/a-C stack, has been formed, the composite carbon layer may optionally be subjected to a thermal anneal in order to reduce or release mechanical stresses, whether compressive and/or tensile stresses, inherent in one or more of the carbon films incorporated in the composite multilayer carbon film. As will be appreciated, the particular combination of temperature(s) and anneal time(s) will depend on the number, composition and relative thicknesses of the incorporated layers. Further, as will be appreciated, the combination of temperature(s) and anneal time(s) will also depend on the techniques and/or processes used to form the various incorporated layers and the stresses incorporated in the layers during the deposition process(es). In other embodiments, however, the deposition conditions and the characteristics of the incorporated carbon layers may be such that no anneal is necessary before separating the composite multilayer carbon film from the substrate.

It is expected that annealing temperatures above 125° C., and typically less than 250° C., for a duration of less than about 3 hours should be sufficient to achieve sufficient relaxation of a composite carbon film including carbon-arc a-C layers sandwiching a laser ablation DLC layer having a thickness ratio on the order of about 2:1:2 and a total composite film thickness on the order of 0.1-50 μm.

The sufficiency of a particular annealing process for a particular composite carbon film will be quickly evident upon the separation of the composite carbon film from the substrate. If the anneal conditions are adequate, the composite carbon film will assume a substantially planar configuration upon separation from the substrate. Films that have not been sufficiently annealed, however, once released from the substrate will bend, curl and/or roll. Subsequent thermal treatment may be sufficient to recover some composite carbon films even after release from the substrate, but in more severe instances the films will probably be unrecoverable.

As noted above, depending on the parting agent selected, an appropriate solvent and removal conditions may be selected. Further, as will be appreciated, although the example embodiment incorporates dissolution as the method for removing the release agent from between the substrate and the composite carbon foil, other materials may be utilized from which the composite carbon film is released by etching or otherwise degrading the parting agent, or select components thereof, to a degree sufficient to release the composite carbon film.

Further, depending on the parting agent(s) utilized, the substrate(s) can be heated to a temperature at which the physical properties of the parting agent(s) are sufficiently altered (by, for example, decomposition or recrystallization) such that the deposited films may be detached from the substrate without damage. Similarly, use of parting agents that can be degraded by exposure to light, for example, deep UV light, in combination with thin carbon layers and/or a transparent substrate(s) would provide alternative methods of releasing the multilayer composite carbon film.

When the composite carbon film is separated from the substrate by a release agent having good solubility in one or more solvents, the substrate 102, with its attached composite carbon film 200, may, as illustrated in FIG. 3, be lowered into a vessel 300 containing a suitable solvent 302 or solvent system under conditions, heat and/or agitation, that will tend to promote dissolution of the release agent whereby the release agent is gradually removed along an axis and the released portion of the composite carbon film 200a remains supported at the surface of the solvent.

Once the composite carbon film has been separated from the substrate, particularly if the release technique included the application of one or more solvents that will or may be expected to result in residual solvent within the film, the composite carbon film may be dried before use. This drying may be accomplished using any appropriate method including, for example, heating the composite carbon film in a dry gas, exposing the composite carbon film to a vacuum (with or without addition of heat) and/or exposing the composite carbon film to one or more desiccants for a period sufficient to reduce or remove a sufficient portion of the residual solvent(s) whereby the composite carbon film is in condition suitable for its intended use.

As will be appreciated, the solvent(s) involved, the immediacy of the intended use and the nature of the composite carbon film may be factors in selecting an appropriate drying method. For example, the composite carbon film can simply be placed on a tray or rack and allowed to dry in air at ambient temperature. Alternatively, the composite carbon films may be dried more quickly using elevated temperatures, or in a vacuum environment, or in the presence of a solvent scavenger, e.g., in a desiccator vessel.

As will also be appreciated by those skilled in the art, the acceptable level of residual solvent in composite carbon film may vary dramatically between intended applications. Similarly, depending on the intended application, at least a portion of the drying may be achieved in situ including, for example, high vacuum applications in which the procedures for bringing the equipment back online after installation of the composite carbon film may achieve adequate drying without any pre-installation treatment. As will be appreciated by those skilled in the art, previously prepared composite carbon films may also be stored for extended periods of time prior to use, typically in a vessel, package and/or carrier that will protect the composite carbon film from mechanical damage and contamination.

### Example

Detailed below is a representative process by which multilayer composite carbon films may be formed in accord with the description detailed above. In this example, a carbon arc deposition technique was utilized for depositing the amorphous carbon layers. The deposition chamber or reaction chamber utilized in this example included a water-cooled stainless steel vacuum chamber with a two stage vacuum pumping system consisting of a primary mechanical pump and a secondary cryogenic pump.

The substrate is placed on a carrier inside the chamber and placed in proximity to carbon rods which are mounted on one or more aligning devices typically configured whereby the positioning of the rods relative to each other and the substrate can be adjusted. The portions of the carbon rods that will be consumed during the deposition may, for example, be positioned about 20 cm above the deposition surface of the substrate. The proximal portions of the carbon rods will also be positioned to provide a relatively small arc gap between adjacent rod tips across which an electrical current will be established.

The electrical current flowing through the carbon rods heats the carbon rods to evaporation temperature at which carbon is released from the rods and into the reaction chamber. During the deposition process, the substrates typically reach temperatures above room temperature and provisions may be made to heat and/or cool the substrate during deposition as desired. The progress of the deposition may be monitored using a crystal thickness monitor or may simply be timed with the resulting layers being sampled to ensure sufficient thickness and uniformity.

Although an a-C layer may be produced using the carbon arc technique described above or any other suitable deposition technique, a laser ablation apparatus may then be used for the subsequent deposition of a diamond-like carbon layer. The reaction chamber in which the DLC layer is formed may be similar to that used in forming the a-C layer, e.g., a water-cooled stainless steel vacuum chamber with a two stage vacuum pumping system consisting of a mechanical primary pump and a cryogenic secondary pump.

The substrate may be provided on a holding apparatus that may be configured using, for example a planetary gear set or other suitable mechanism, that moves the substrate through a deposition region about 20 cm from one or more sputter targets. The movement of the substrate relative to the sputter target(s) tends to provide a more uniform deposition. In this example, a Nd:YAG infrared laser beam was directed onto a sputter target using an optical focussing system. The focused laser beam, in turn, heats the sputter target to a point where single carbon atoms or small clusters of carbon atoms evaporate from the target. The carbon atoms released from the sputter target are, in turn, deposited on the substrates to form a DLC layer. Throughout the deposition process, the substrates does not typically incur much heating and may, therefore, be maintained at a temperature near ambient, on the order of perhaps 25-35° C., thereby expanding the range of temperature-sensitive materials that may be used in forming the release layer. The progress of the deposition may be monitored by a crystal thickness monitor.

### Production of a 2 μm Tri-Layer Self-Supporting Foil

Polishing of substrates—The substrates, in this instance, are simply commercially available, pre-cleaned microscope slides having a nominal size of ˜25 mm×75 mm size and typically <1 μm surface roughness. The substrates are next washed with distilled water and subsequently with methanol. After the substrates have been washed, they may be dried in a drying chamber or manually using Kimwipes® or similar paper to absorb any residual surface solvent in order to provide a substrate having a reduced solvent component.

Application of Release Agent—Although the use of release agents is optional, in this instance a drop (˜50 μL) of a 7:1 betaine-saccharose solution (as a release agent) was then applied to the polished surface of each slide. The solution was then distributed across the deposition surface to form an even coating of release agent. The slides were then polished with Kimwipes® or similar paper until all visible traces of release agent have been removed.

Coating with Amorphous Carbon—The substrates were placed in a carbon arc deposition system and coated with 0.5 μm of amorphous carbon by applying a current of approximately 50-200 amperes through the carbon rods while the deposition chamber is maintained at a pressure of about 4×10⁻⁴ Pa. The deposition system is operated in pulsed mode, with approximately 10 second pulses in 5 minute intervals. After the desired thickness of 0.5 μm has been achieved, the substrates were allowed to cool for approximately one hour.

Production of a DLC Layer—The substrates previously coated with amorphous carbon are mounted into the vacuum chamber of the laser ablation system. After a sufficient degree of vacuum has been established within the deposition chamber (again, about 4×10⁻⁴ Pa), a carbon target, typically a graphite target, is then exposed to a focused laser beam in order to release carbon into the reaction chamber. Typically, an energy density of approximately 75 J/cm² applied to a graphite target is sufficient to achieve a deposition rate on the order of 0.02-0.1 nm/s. When the desired thickness of the DLC layer of 1.0 μm has been reached, the deposition is terminated.

Coating with Amorphous Carbon—Another layer of amorphous carbon of 0.5 μm thickness is applied by following the procedure described above.

Annealing—Although annealing is not necessarily required, in this instance the substrates were placed in a vacuum oven (typical pressure 1 to 10⁻² Pa) and annealed at a typical temperature of 170° C. for 2-3 hours. The coated and annealed substrates were then allowed to cool to a temperature below 50° C. before being removed from the annealing oven.

Separating the Composite Film from the Substrate—In this instance, as a result of the use of the water-soluble release agent, the composite film was removed from the substrate by slowly immersing the coated slide into a water bath maintained at a temperature of about 50 to 70° C. as illustrated in FIG. 3. As the release agent dissolved, the composite carbon film separated from the substrate and, in this instance, the composite carbon film floated on the water surface from which it could easily be retrieved.

Removal of the Foil, Drying and Cutting—After separation of the composite carbon film from the substrate is complete, the floating composite carbon film may be removed from the surface of the separation bath using a polyethylene sheet having a thickness on the order of ˜0.2 mm and configured to have dimensions slightly larger than the carbon film that is to be recovered. The polyethylene sheet was immersed in the separation bath, placed under the floating film and then withdrawn from the separation bath. The a-C surfaces of the composite carbon film tend to exhibit sufficient adhesion to the polyethylene sheet to maintain the positioning of the composite carbon film on the sheet and thereby provide mechanical support to the film during the removal process.

The composite carbon film and the polyethylene sheet were then placed on a flat surface for an initial drying period. This initial drying period may proceed under ambient conditions and need not include the use of heat, desiccants or other methods for accelerating the drying. Once the composite carbon film is sufficiently dry, it can be lifted from the polyethylene sheet and trimmed or cut to the desired size(s) using a conventional utility blade or other cutting instrument. If desired, the composite carbon film can also be subjected to additional drying and/or prepared for mounting on a frame, carrier or other structure that will be used to hold and/or position the composite carbon film during subsequent use as, for example, a stripping foil.

While the invention has been particularly shown and described with reference to example embodiments thereof, it will be understood by those of ordinary skill in the art that various changes in form and details may be made therein without departing from the spirit and scope of the invention.

1. A self-supporting multilayer composite carbon film comprising:
a first non-diamond-like carbon layer; and
a diamond-like carbon layer.

2. The self-supporting multilayer composite carbon film according to claim 1, further comprising:
a second non-diamond-like carbon layer cooperating with the first non-diamond-like carbon layer to sandwich the diamond-like carbon layer therebetween; wherein
the multilayer composite carbon film has a total thickness of about 0.1 μm to 50 μm; and
a thickness of the first non-diamond-like carbon layer Tai, a thickness of the diamond-like carbon layer T_{dlC}, and a thickness of the second non-diamond-like carbon layer Tₐ₂ form a thickness ratio of about 1-10:1:1-10.

3. The self-supporting multilayer composite carbon film according to claim 1, further comprising:
a second non-diamond-like carbon layer cooperating with the first non-diamond-like carbon layer to sandwich the diamond-like carbon layer therebetween; wherein
the multilayer composite carbon film has a total thickness of about 0.1 μm to 50 μm; and
a thickness of the first non-diamond-like carbon layer Tₐ₁, a thickness of the diamond-like carbon layer T_{dlc}, and a thickness of the second non-diamond-like carbon layer Tₐ₂ form a thickness ratio of about 1:1-100:1.

4. The self-supporting multilayer composite carbon film according to claim 1, further comprising:
a plurality Nₐ of non-diamond-like carbon layers and a plurality N_{d} of diamond-like carbon layers arranged in an alternating configuration.

5. The self-supporting multilayer composite carbon film according to claim 4, wherein:
the plurality Nₐ of non-diamond-like carbon layers and the plurality N_{d} of diamond-like carbon layers satisfy the expression (N_{d}+1)=Nₐ.

6. The self-supporting multilayer composite carbon film according to claim 4, wherein:
the plurality Nₐ of non-diamond-like carbon layers and the plurality N_{d} of diamond-like carbon layers satisfy the expression |(N_{d}−Nₐ)|≦1.
